(19) United States
(12) Patent Application Publication
(10) Pub. No.: US 2013/0060674 A1
(43) Pub. Date: Mar. 7, 2013

(54) Systems, method, and media for trading deconstructed stocks

(71) Applicants: Jeffrey A. Citron, Brielle, NJ (US); Jeffrey R. Parkinson, Middletown, NJ (US); Brian L. Aoaeh, Atlantic Highlands, NJ (US)

(72) Inventors: Jeffrey A. Citron, Brielle, NJ (US); Jeffrey R. Parkinson, Middletown, NJ (US); Brian L. Aoaeh, Atlantic Highlands, NJ (US)

(21) Appl. No.: 13/593,223

(22) Filed: Aug. 23, 2012

Related U.S. Application Data
(60) Provisional application No. 61/526,583, filed on Aug. 23, 2011.

(51) Int. Cl. G06Q 40/04

(52) U.S. Cl. 705/37

(57) ABSTRACT

System for trading deconstructed stocks are provided, the systems comprising: at least one hardware processor that: obtains a share of a stock from a public equity market; constructs an equity only share, a dividend only share, and a voting right only share corresponding to the stock: determines a first price for the equity only share; determines a second price for the dividend only share; presents the first price to a first of two traders; presents the second price to a second of two traders; matches trading interests between the two traders involving the equity only share and dividend only share; and executes a trade between the two traders involving the equity only share and dividend only share.

### CROSS REFERENCE TO RELATED APPLICATIONS

This application claims the benefit of U.S. Provisional Patent Application No. 61/526,583, filed Aug. 23, 2011, which is hereby incorporated by reference herein in its entirety.

### TECHNICAL FIELD

System, method, and media for trading deconstructed stocks are provided.

### BACKGROUND

There are a number of qualities that make dividend-paying common stock attractive to investors. Investors typically view the payment of cash dividends as a sign of financial profitability, strength, and stability. Investors also typically interpret the payment of cash dividends as a sign of alignment; between the interests of management and a company's shareholders.

Investors in dividend-paying companies may generally be divided broadly into two categories. One group invests primarily in order to benefit from growth in shareholders' equity as the companies' financial results translate into an increase in the public market valuation of the companies' equity. The second group invests primarily in order to benefit from the periodic cash-dtvidends that the company pays. The first group places little or no value in the periodic dividend payments. The second group places little or no value on growth in stockholders' equity.

There is a need for a straightforward and transparent means for these two groups of investors to tailor their investment in publicly traded dividend-paying companies more closely to their interests, investment strategy, and financial obligations.

### SUMMARY

Systems, methods, and .media for trading deconstructed stocks are provided. In accordance with some embodiments, systems for trading deconstructed stocks are provided, the systems comprising: at least one hardware processor that: obtains a share of a stock from a public equity market; constructs an equity only share, a dividend only share, and a voting right only share corresponding to the stock; determines a first price for the equity only share; determines a second price for the dividend only share; presents the first price to a first of two traders; presents the second price to a second of two traders; matches trading interests between the two traders involving the equity only share and dividend only share; and executes a trade between the two traders involving the equity only share and dividend only share.

In accordance with some embodiments, methods for trading, issuing, and redeeming deconstructed stocks are provided, the methods comprising; obtaining a share of a stock from a public equity market; constructing an equity only share, a dividend only share, and a voting right only share corresponding to the stock; determining a first price for the equity only share; determining a second price for the dividend only share; presenting the first price to a first of two traders; presenting the second price to second of two traders; matching trading interests between the two traders involving the equity only share and dividend only share; and executing a trade between the two traders involving the equity only share and dividend only share.

In accordance with some embodiments, non-transitory computer-readable media containing computer-executable instructions that, when executed by a processor, cause the processor to perform a method for trading, issuing, and redeeming deconstructed stocks are provided, the method comprising: obtaining a share of a stock from a public equity market; constructing an equity only share, a dividend only share, and a voting right only share corresponding to the stock; determining a first price for the equity only share; determining a second price for the dividend only share; presenting the first price to a first of two traders; presenting the second price to second of two traders; matching trading interests between the two traders involving the equity only share and dividend only share; and executing a trade between the two traders involving the equity only share and dividend only share.

### BRIEF DESCRIPTION OF THE DRAWINGS

FIG. 1 is a diagram of a process for conducting an electronic, auction for Voting Shares in accordance with some embodiments,

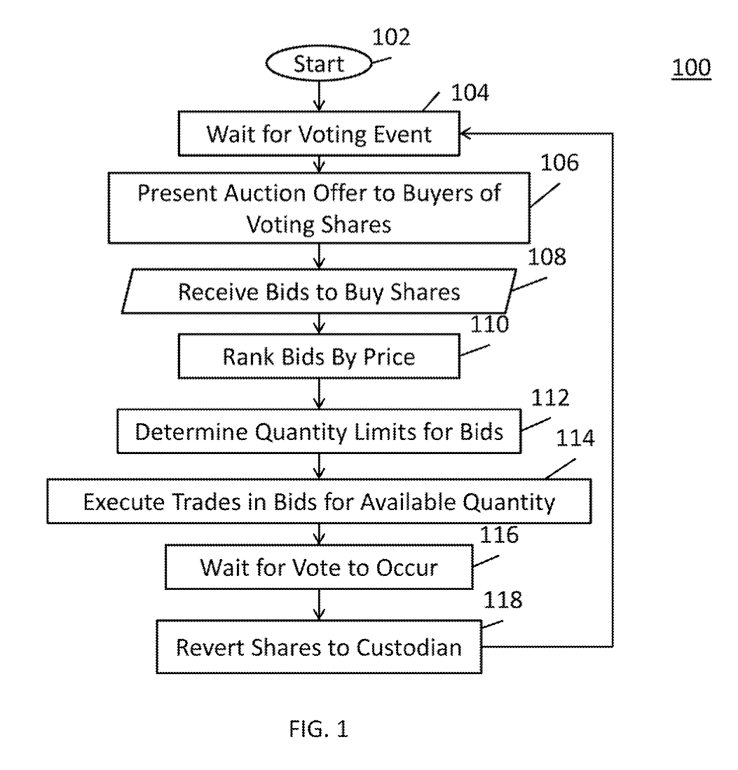

FIG. 2 is a block diagram of an architecture for trading, issuing, and redeeming deconstructed stocks in accordance with some embodiments.

### DETAILED DESCRIPTION

Systems, method, and media for trading, issuing and redeeming deconstructed stocks are provided.

In accordance with some embodiments, mechanisms for deconstructing a publicly traded, dividend-paying common stock and transforming the original security into equity, debt, and voting right securities are provided. This deconstraction unlocks value that is otherwise hidden in the dividend-paying common share and permits investors to tailor their investment in dividend-paying common shares more closely to their investment strategy and financial goals.

As used herein, the terms “dividend-paying common stock” and “dividend-paying common share” refer to publicly traded common shares or stock whose issuer(s) pay a cash-dividend.

In accordance with some embodiments, in order to implement a deconstruction of a share of a regularly trading, dividend-paying stock, a physical or electronic record of ownership for the share of the stock can be taken out of circulation from the stock markets. In. exchange one or more, investors can be issued a physical or electronic record of ownership that is different from the record that has been taken out of circulation and that will indicate whether it represents an interest in future growth in stockholder's equity only, future dividend payments only, or a right to vote. In other words, each physical share of the regularly trading, dividend-paying stock can undergo a transformation in which one share is taken in and converted into three unique, mutually distinct, and discrete shares, each of which is materially different from the dividend-paying share it was created from, and each of which will possess a unique identifier.

In accordance with some embodiments, such mechanisms cm form or use a pool of investor capital (which pool can be referred to as a Master Equity Trust Structure (METS)) to purchase underlying dividend-paying shares to be deconstructed. A METS can be used to buy any suitable shares, such as shares in Dow and S&P500 dividend paying stocks and/or any other suitable stocks.

After deconstructioa, the underlying shares can be transformed into equity only shares (which can be referred to as “Discounted Equity Linked Trust Shares (DELTS)”), dividend paying only shares (which can be referred to as “Preferred Equity Linked Trust Shares (PELTS)”), and voting right only (which can be referred to as “Voting Shares”) in some embodiments.

In some embodiments, DELTS are derivative equity securities that are issued by the METS and are similar to the underlying stock from which they are derived, except that they do not pay a dividend and are purchased at a discount. In some embodiments, the price of DELTS can move dollar for dollar with the underlying security.

In some embodiments, PELTS are derivative debt-like securities that are issued by the METS that pay a dividend stream based on the dividend of the underlying stock from which they are derived. PELTS can be used to provide the capital to fund the discount on the DELTS, which in turn, can be used to provide securitization to the PELTS. PELTS can be issued and fully redeemable at par and can carry various maturity lengths. PELTS can earn a required rate of return, determined by the market, on a periodic basis.

In some embodiments, additionally or alternatively to using PELTS, Secured Equity Notes (SEN) can be used, SEN are securities that are similar and pari passu to PELTS, except that SEN pay interest income for investors who do not wish to own a dividend-paying instrument.

In some embodiment, Voting Shares are shares that represent the right to vote as a shareholder in the underlying slock.

In accordance with some embodiments, mechanisms for pricing such DELTS, PELTS (and/or SEN), and Voting Shares can be provided.

The value of an asset can he generally calculated as the present value of the future cash flows that an investor expects to receive from the asset. For a dividend-paying stock these cash flows can be represented by the cash dividends that the company pays to the investor, and the price at which the stock is sold on the market if the investor sells it after holding it for some time. Thus, the price of the stock can be calculated as the sum of the present value of each dividend that the investor expects to be paid during the period that the investor holds the stock, and the present value of the price of the stock at the end of the holding period.

For example, the value of such an asset can be calculated as:

$${V}_{0} = {\sum }_{t = 1}^{n} \frac{{D}_{t}}{{( 1 + r )}^{t}} + \frac{{P}_{n}}{{( 1 + r )}^{n}}$$

where:

V₀=the value of one share of dividend-paying stock today, at time t = 0

Pₙ=the price at which the investor sells the stock at the end of the holding period

Dₜ=the expected dividend per share, assumed to be paid at the end of each of n periods

r=the rate of return or growth rate that the investor expects to realize

if the investor's holding period extends indefinitely, then the value of such an asset can be calculated as:

$${V}_{0} = {\sum }_{t = 1}^{∝} \frac{{D}_{t}}{{( 1 + r )}^{t}}$$

The dividend paying common share valued using the preceding formulae has three principal components:

1) The right to participate in growth in shareholders' equity;

2) The right to receive periodic dividend payments:, and

3) The right to vote on issues put before shareholders by corporate management.

The formulae discussed above make it possible to value the first two components. However, the underlying value of the third component is difficult to assess.

Another way of expressing this is to rewrite the formula for the value of one share of a dividend paving stock as:

$${V}_{0} = {\sum }_{t = 1}^{∝} \frac{{D}_{t}}{{( 1 + r )}^{t}} + {ɛ}_{t}$$

where εₜ is a residual value that represents the value of an investor's right to vote on an issue placed before shareholders at a specific point in time.

The value of εₜ is typically determined by individual investor interest in a particular vote on an issue. Because, the issues which management wishes to put before holders of common stock are typically communicated in advance of votes being cast, investors are able to make an informed assessment about the value they attach to their right to vote, each time they are required to cast their vote.

Assuming constant growth in future dividends, the expected dividend payment at any point in time t, can be obtained by applying the dividend growth rate g to the dividend paid in the preceding period. Taking the most recent dividend payment and compounding it by g for the appropriate number of periods yields the same result.

Mathematically, this can be represented as:

Dₜ=Dₜ₋₁(1+g)=D₀(1+g)^{t}

Based on this representation, the equation for the value of a share of dividend-paying common stock can be re-written as;

$${V}_{0} = {\sum }_{t = 1}^{∝} \frac{{{D}_{0} ( 1 + g )}^{t}}{{( 1 + r )}^{t}} + {ɛ}_{t}$$

Assuming r>g, this re-written equation can then be simplified to:

$${V}_{0} = \frac{{D}_{0} ( 1 + g )}{r - g} + {ɛ}_{t}$$

In accordance with some embodiments, DELTS can be purchased by investors who are willing to forego the right to future dividend payments, but who want ownership rights to future growth in shareholders' equity only. The DELTS can be purchased at a discount to the price at which the underlying stock trades on the public equity markets.

Mathematically, based on the price formula for underlying stock above, the price for the DELTS can be represented as:

$$( 1 - E D R ) \frac{{D}_{0} ( 1 + g )}{r - g}$$

As can be seen, the discount on the price of the underlying stock is reflected here by EDR, the Equity Discount Rate, which is a value between 0 and 1. In some embodiments, the value of EDR can be set by the investors in DELTS.

The total amount of capital invested in DELTS can be referred to as the Equity Pool (EP), and the ratio of the Equity Pool to the METS can be referred to as the Equity Pool Ratio (EPR).

Similarly, in accordance with some embodiments, PELTS can be purchased by investors who are willing to forego the right to future growth in shareholder's equity, but who want ownership rights to the future dividend stream only of the stock. Additionally or alternatively, SEN can be purchased by investors who want to receive interest income but do not wish to own a dividend-paying instrument.

Mathematically, based on the price formula for underlying stock above, the price for PELTS and/or SEN can be represented as:

$$( E D R ) \frac{{D}_{0} ( 1 + g )}{r - g}$$

Once again, as can be seen, the discount on the price of the underlying stock is reflected here by EDR, the Equity Discount Rate.

The total par value of PELTS and/or SEN can be referred to as the Debt Pool (DP), the ratio of the Debt Pool to the METS can be referred to as the Debt Poo! Ratio (DPR), and the ratio of the METS to the Debt Pool (which is equal to one divided by the EDR) can be referred to as the METS Debt Coverage Ratio (MDCR).

The minimum OCR required by investors to secure the Debt Pool can be referred to as the Debt Minimum Coverage Ratio (DMCR). In some embodiments, each PELTS holder can select a minimum DCR for their share(s) at initiation of the METS, These holders can have the option to sell, or have the METS redeem, their PELTS if the DCR is equal to or less than the DMCR due to market, conditions in some embodiments. This sale can be completed automatically or with the assistance of a person with client portfolio/responsibility for risk management.

In accordance with some embodiments, at each point in time at which there are issues on which investors in stock have a right to vote, an electronically administered auction can be used to price and sell the voting rights as Voting Shares for that stock based on investor interest in those vori.ua rights.

An example of a process 100 for an electronically administered auction for selling voting rights shares in accordance with some embodiments is shown in FIG. .1. As illustrated, after process 100 begins at 102, the process waits for a voting event on which investors in stock have a right to vote. Next, at 106, auction offers are presented to potential buys of Voting Shares.

In order to participate in such an auction (i.e., be a potential buyer of Voting Shares), an investor can be required to meet certain requirements, such as that the investor holds some combination of DELIS and PELTS (e.g., in order to comply with current securities regulations). For example, in some embodiments, as long as an investor holds equity or dividend shares in the entity, he or she may elect to purchase any number of voting shares (whole units only) from 0% to 100% of their total holdings. More particularly, for example:
If investor A purchases 50 shares of equity interest, he may then elect to purchase any number of voting shares from 0 to 50 (in whole shares).
If investor B purchases 200 shares of the dividend interest, she may elect to purchase any number of voting shares from 0 to 200 (in whole shares),
If investor C purchases 100 equity shares as well as 100 dividend shares, he may now purchase any number of voting shares from 0 to 200 (in whole shares).
If investor D holds 50 shares of equity and 40 voting shares and decides to sell 30 shares of his equity stake, he will then be required to sell a minimum of 20 voting shares in order to avoid carrying a voting interest thai exceeds his economic interest.

Any suitable offers can be presented. For example, an offer can specify the name of the company, a description of an issue on which a vote is going to be held, a minimum price that must be received be able to buy Voting Shares via the auction, terms of the auction, etc. These offers can be delivered to potential buyers using any suitable mechanism. For example, the offers can be presented through email, instant, messages, a graphical user interface, etc.

Next, at 108, bids to buy voting shares are received. These bids can be received in any suitable manner. For example, these bids can be received via email, instant messages, a graphical user interface, etc.

The received bids can then be ranked by price so that the highest bids are ranked at the top of a list at 110. In some embodiments, bids can additionally or alternatively be ranked on a quality of the bids. For example, a bid can be deemed to be of a higher quality if a corresponding potential buyer has better than average credit.

Quantity limits for bids can next be determined at 112. For example, as described above, a potential buyer can be limited to buying only a certain number of voting shares based on. the number of equity shares and dividend shares held. Trades can then be executed for the highest ranking bids based on their quantity limits until the Voting Shares are all sold at 114.

At 116, process 100 can wait for the vote to occur, and, once voting has been completed, the Voting Shares can revert to a custodian for use in conducting subsequent auctions at 118.

The value of the voting rights in the Value Shares can be referred to as the Voting Pool (VP).

In accordance with some embodiment, the Gross Return on DELTS during a holding period can be determined. This Gross Return can vary based on whether the investor is receiving dividends during the holding period or not. For the case where there is no reinvestment of dividends aid with dividends paid annually, the Gross Return with dividends paid (Gory) can be calculated as:

I+G_{DIV}=(1+R)^{N}+N∴D_{Y}

G_{DIV}=[(1+R)^{N}+N×D_{Y}[−1

where:

R is the Growth Rate periodic rate of return computed on a compounded basis with annual compounding;
N is the number of years (whether integer or non-integer) of the term of the investment under consideration in the METS; and
D_{Y} is the dividend paid by a dividend paying stock that is used in setting up a given Master Equity Trust Structure.

Dividend Yield (d_{Y}): Represents the dividend-yield for a given dividend paying stock that is used in setting up a given Master Equity Trust Structure.

For the case where the investor is not earning dividends, the Gross Return without dividends paid (G_{EXDIV}) can be calculated as:

In accordance with some embodiments, a hurdle rate can be determined. The hurdle rate can represent the minimum acceptable holding period return that DELTS investors require for a given term. It can be a top-up rate of return that DELTS investors require in order to compensate them for giving up the returns that would have been realized if they had held onto the dividend stream.

If we let k represent an arbitrary constant, a relationship between G_{DIV} and G_{EXDIV} can be represented as:

$${G}_{DIV} = {G}_{EXDIV} + k$$

$$1 = \frac{{G}_{EXDIV}}{{G}_{DIV}} + \frac{k}{{G}_{DIV}}$$

Rearranging terms, and letting

$${H}_{N} = \frac{k}{{G}_{DIV}}$$

the hurdle rate for an N˜year investment (H_{N}) can be represented as:

$${H}_{N} = 1 - \frac{{G}_{EXDIV}}{{G}_{DIV}}$$

Substituting appropriately for G_{DIV} and G_{EXDIV}, H_{N} can be represented as;

$${H}_{N} = 1 - \frac{{( 1 + R )}^{N} - 1}{[ {( 1 + R )}^{N} + N \times {D}_{Y} ] - 1} \qquad ( 1 )$$

By performing the appropriate algebraic manipulations, the Growth Rate, R, can be represented as:

$$R = {[ ( 1 + \frac{N \times {D}_{Y}}{{H}_{N}} ) - N \times {D}_{Y} ]}^{\frac{1}{N}} - 1 \qquad ( 2 )$$

Thus, for an investment horizon of N years, equations (1) and (2) above respectively enable the determination of:
The N-year Hurdle Rate (N_{N}) that a DELTS investor requires given a stated Growth Rate (R); and
The annual Growth Rate (R) that a DELTS investor requires given a stated N˜Year Hurdle Rate (H_{N}).

By means of equation (2) above, the price of DELTS and PELFS can be calculated as follows.

As set forth above, the price for DELTS can be represented as:

$$D E L T S = ( 1 - E D R ) \frac{{D}_{0} ( 1 + g )}{r - g}$$

Let R=r, so that; based on this equation and equation (2), the price of DELTS can be represented as:

$$DELTS = ( 1 - EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g}$$

Similarly, as set forth above, the price for PELTS can be represented as:

$$PELTS = ( EDR ) \frac{{D}_{0} ( 1 + g )}{r - g}$$

Again, letting R=r, so that, based on this equation and equation (2), the price of PELTS can be represented as:

$$PELTS = ( EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g}$$

The immediately preceding equations above demonstrate that, for a given dividend-paying common stock, the price of a BELTS can be determined, and thus, the price of a matching PELTS can also be determined. These determinations can be made based on a hurdle-rate assumption and a dividend growth rate assumption that can be provided by an investor.

Once these assumptions are received, the investor can be provided with an array of DELIS prices at various EDR values and investment terms.

Once the BELTS investor has indicated a choice from such an array, PELTS and/or SEN investors can be provided with corresponding information in the form of an array showing the price at which they may invest in the corresponding PELTS or SEN, the term for that investment, and what that translates to in terms of yield-to-maturity.

In accordance with some embodiments, formulas equivalent to equations (1) and (2) above can be derived as if BELTS investors earned a dividend that is then reinvested. The Gross Return with dividends earned and reinvested (Gdiv) can be calculated as:

$$1 + {G}_{DIV} = {( 1 + R )}^{N} + {\sum }_{i = 1}^{N} [ {D}_{{Y}_{i}} \times {( 1 + R )}^{i} ]$$

$${G}_{DIV} = [ {( 1 + R )}^{N} + {\sum }_{i = 1}^{N} [ {D}_{{Y}_{i}} \times {( 1 + R )}^{i} ] ] - 1$$

where:

D_{Yi} represents the ith dividend,

Then, substituting appropriately, H_{N} can be represented as:

$${H}_{N} = 1 - \frac{{( 1 + R )}^{N} - 1}{[ {( 1 + R )}^{N} + {\sum }_{i = 1}^{N} [ {D}_{{Y}_{i}} \times {( 1 + R )}^{i} ] ] - 1}$$

The immediately preceding equation assumes that dividends are reinvested at a growth rate equal to R. This is generally not the case in practice. Assuming that each dividend is reinvested at a rate of return rᵢ, H_{N} can be represented as:

$${H}_{N} = 1 - \frac{{( 1 + R )}^{N} - 1}{[ {( 1 + R )}^{N} + {\sum }_{i = 1}^{N} [ {D}_{{Y}_{i}} \times {( 1 + {r}_{i} )}^{i} ] ] - 1} \qquad ( 3 )$$

Furthermore, the above equation can be solved for R as was done in the case with no reinvestment of dividends:

$$R = {[ ( 1 + \frac{{\sum }_{i = 1}^{N} [ {D}_{{Y}_{i}} \times {( 1 + {r}_{i} )}^{i} ]}{{H}_{N}} ) - {\sum }_{i = 1}^{N} [ {D}_{{Y}_{i}} \times {( 1 + {r}_{i} )}^{i} ] ]}^{\frac{1}{N}} - 1 \qquad ( 4 )$$

For an investment horizon of N years, equations (3) and (4) respectively enable the following to be determined:
The N-Year Hurdle Rate (H_{N}) that an investor might require given a stated annual Growth Rate (R) and an annual dividend D_{Yi}, with each dividend reinvested at a corresponding growth rate rᵢ; and
The annual Growth Rate (R) that an investor might require given a stated N-Year Hurdle Rate (H_{N}) and an annual dividend D_{Yi}, with each dividend reinvested at a corresponding growth rate rᵢ.

Following the procedure used above for pricing DELTS and PELTS and substituting appropriately from equation (4), DELTS (in which DELTS investors earn a dividend that is then reinvested) can be priced as:

$$DELTS = ( 1 - EDR ) \frac{{D}_{0} ( 1 + g )}{( {[ ( 1 + \frac{{\sum }_{i = 1}^{N} [ {D}_{{Y}_{i}} \times {( 1 + {r}_{i} )}^{i} ]}{{H}_{N}} ) - {\sum }_{i = 1}^{N} [ {D}_{{Y}_{i}} \times {( 1 + {r}_{i} )}^{i} ] ]}^{\frac{1}{N}} - 1 ) - g}$$

Similarly, corresponding PELTS can be priced as:

$$PELTS = ( EDR ) \frac{{D}_{0} ( 1 + g )}{( {[ ( 1 + \frac{{\sum }_{i = 1}^{N} [ {D}_{{Y}_{i}} \times {( 1 + {r}_{i} )}^{i} ]}{{H}_{N}} ) - {\sum }_{i = 1}^{N} [ {D}_{{Y}_{i}} \times {( 1 + {r}_{i} )}^{i} ] ]}^{\frac{1}{N}} - 1 ) - g}$$

These determinations can be made based on a hurdle-rate assumption and a dividend growth rate assumption that can be provided by an investor. Once these assumptions are received, the investor can be provided with an array of DELTS prices at various EDR values, dividend reinvestment rates, and investment terms.

In accordance with some embodiment, the Yield, y (i.e., the single rate at which the PELTS/SEN cash flows are discounted in order to calculate the PELTS/SEN price at the point in time at which the METS is created), on PELTS and/or SEN during a holding period can be determined. This Yield can vary based on whether the investor is receiving dividends during the holding period (PELTS) or not (SEN). For the case where there is no reinvestment of dividends and with dividends paid annually, the Yield can be determined as follows in some embodiments.

First, the general formula for calculating a price (P) for a bond can be obtained by, over the N years of investment, adding the sum of the present value (PV(D_{y})) of all the dividend payments (D_{y}; i.e., the product of dividend yield and the face value or par value of a PELTS) to the present value (PV(F)) of the face or maturity value (F) of the bond at its maturity date. Mathematically, this formula can be represented as:

$$P = {\sum }_{i = 1}^{N} PV ( {D}_{y} ) + PV ( F )$$

Using the variables previously listed, this price can be represented as:

$$P = {\sum }_{i = 1}^{N} \frac{{D}_{y}}{{( 1 + y )}^{i}} + \frac{F}{{( 1 + y )}^{N}}$$

The formula above inherently assumes that dividends are reinvested at a growth rate y.

Using the expression for the price of PELTS set forth above, the price can be represented as:

$$( EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g} = {\sum }_{i = 1}^{N} \frac{{D}_{y}}{{( 1 + y )}^{i}} + \frac{F}{{( 1 + y )}^{N}} \qquad ( 5 )$$

Note that D_{Y} and D_{Y} may not be equal. In fact, in practice the former can typically be greater than the latter.

In some embodiments, PELTS redeem at par. Therefore F=P, and thus the preceding formula can be rewritten as:

$$( EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g} = {\sum }_{i = 1}^{N} \frac{{D}_{y}}{{( 1 + y )}^{i}} + \frac{[ ( EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g} ]}{{( 1 + y )}^{N}}$$

Over an investment horizon of JV years, equation (5) enables the yield (y) that an investor might earn given a stated annual dividend (D_{y}) to be determined.

Thus, potential PELTS can be presented to investors with an array of yield-to-maturity options on which they can bid based on information obtained from DELTS investors.

For the case where dividends are not paid out periodically (SEN), and instead the investor realizes interest as the difference between the price (P) and the face value (F) at redemption, the Yield can be determined as follows in some embodiments.

First, the general formula for calculating a price (P) for a bond can he obtained by setting the price equal to the present value (PF(F)) of the face or maturity value (F) of the bond at its maturity date. Mathematically, this formula can be represented as:

$$P = PV ( F )$$

$$P = \frac{F}{{( 1 + y )}^{N}}$$

Note that y in the preceding equation can be equal to the yield-to-maturity calculated using equation (5).

The preceding equation can then be rearranged, as:

F=P(1+y)^{N}

Substituting for P the price for SEN presented above, the face or maturity value (F) of the bond at its maturity date can be represented as:

$$F = [ ( EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g} ] {( 1 + y )}^{N} \qquad ( 6 )$$

Thus, a SEN investor can. be presented with the face value that a SEN share will have at redemption.

In accordance with some embodiments, DELTS, PELTS/SEN, and/or Voting Shares can be used for futures trading, spot market trading, forward trading, swap trading, options trading, and ETFs.

Example calculations in accordance with some embodiments are provided below. It should be noted that the calculations below do not account for transaction costs.

Consider a dividend-paying stock selling on the market for a price of $20. It pays an annual dividend yield of 3%, which remains constant. An equity investor believes that a 5% annual growth rate or rate of return is appropriate for the level of risk that an investment in this stock entails. The investor has a 10-year investment horizon.

Recall that:

1+G_{DIV}=(1+R)^{N}+N×D_{Y}

So, when D_{Y}=d_{y}:

t+G_{DIV}=(1.05)¹⁰+10×(0.03)

G_{DIV}=[(1.05)¹⁰+10×(0.03)]−1

G_{DIV}=0.9289

Assuming non-reinvestment of dividends, the investor will realize a return of 92.89% over the ten-year investment term.

Recall that:

1+G_{EXDIV}=(1+R)^{N}

### So:

G_{EXDIV}=(1+R)^{N}−1

G_{EXDIV}=(1.05)¹⁰−1

G_{EXDIV}=0.6289

If the investor had forgone the dividend payments, and had only relied on the equity appreciation for returns, the return over the 10-year term would have been 62.89%.

Recall that the 10-year Hurdle Rate was described above as the “top-up” rate that would cause the investor in this stock to be indifferent between receiving the dividend stream and foregoing that dividend stream.

Also recall that:

$${H}_{N} = 1 - \frac{{G}_{EXDIV}}{{G}_{DIV}} = 1 - \frac{{( 1 + R )}^{N} - 1}{[ {( 1 + R )}^{N} + N \times {D}_{Y} ] - 1}$$

So, for the investor:

$${H}_{N} = 1 - \frac{{G}_{EXDIV}}{{G}_{DIV}} = 1 - \frac{0.6289}{0.9289} = 0.3230$$

This means that during the 10-year investment term, the investor will be willing to forego dividend payments in exchange for an extra 32.30% of growth in equity, assuming no reinvestment of dividends.

Recall that an equation for the annual growth rate or rate of return that is implicitly assumed by a given N-year Hurdle Rate was derived as:

$$R = {[ ( 1 + \frac{N \times {D}_{Y}}{{H}_{N}} ) - N \times {D}_{Y} ]}^{\frac{1}{N}} - 1$$

So, for this example:

$$R = {[ ( 1 + \frac{10 \times 0.03}{0.3230} ) - 10 \times 0.03 ]}^{\frac{1}{10}} - 1$$

$$R = 0.05$$

This agrees with the assumption that the investor believes that a growth rate of 5 percent per annum is appropriate for the level of risk that accompanies this investment.

Assume that the investor has no need for the dividend payments that investing in this stock entails. Another way to go about earning the holding period return of 92.89% over the 10-year investment term would be to sell the dividend stream to another investor for 32.30% of the price of the stock.

That means there is a trade between the DELTS investor and a PELTS investor that involves the DELTS investor trading the right to all future dividend payments to the PELTS investor in exchange for the PELTS investor subsidizing the purchase of the dividend paying stock on the open market.

The DELTS and PELTS trades can be priced as:

DELTS=$20.00×(1−0.3230)=$13.54

PELTS=$20.00×0.3230−$6.46

The yield-to-maturity, y, which the PELTS investor earns over the 10-year period, can be calculated as follows.

First recall that:

$$( EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g} = {\sum }_{i = 1}^{N} \frac{{D}_{y}}{{( 1 + y )}^{i}} + \frac{[ ( EDR ) \frac{{D}_{0} ( 1 + g )}{( {[ ( 1 + \frac{N \times {D}_{Y}}{{H}_{N}} ) - N \times {D}_{Y} ]}^{\frac{1}{N}} - 1 ) - g} ]}{{( 1 + y )}^{N}}$$

Also recall that, the price of a PELTS has been calculated as being equal to $6.46.

Then, for this example:

$$\$6 .46 = {\sum }_{i = 1}^{N} \frac{{D}_{y}}{{( 1 + y )}^{i}} + \frac{\$6 .46}{{( 1 + y )}^{N}}$$

Next, it is assumed that the PELTS investor wishes to receive an annual dividend yield that is equivalent to 95% of the actual annual dividend yield paid by the company to its shareholders. It is also assumed that this amount remains constant for the duration of the investment. Inherently, this calculation assumes that the dividend payments are reinvested at a growth rate or interest rate equal to the yield.

Then:

$$\$6 .46 = {\sum }_{i = 1}^{10} \frac{\$0 .57}{{( 1 + y )}^{i}} + \frac{\$6 .46}{{( 1 + y )}^{10}}$$

which gives y=8.8235% per annum.

The bond-equivalent yield can be obtained by solving the equation:

$$\$6 .46 = {\sum }_{i = 1}^{20} \frac{\$0 .2850}{{( 1 + \frac{y}{2} )}^{i}} + \frac{\$6 .46}{{( 1 + \frac{y}{2} )}^{20}}$$

which results in a bond-equivalent yield of 4.4118%.

The bond-equivalent yield reflects an assumption that the investor receives dividend payments twice a year, at. six-month intervals.

Finally, a yield that corresponds to the number of regular dividend payments each year can be calculated. In doing so, it is assumed that dividends are paid on a quarterly basis.

### Then:

$$\$6 .46 = {\sum }_{i = 1}^{40} \frac{0.1425}{{( 1 + \frac{y}{2} )}^{i}} + \frac{\$6 .46}{{( 1 + \frac{y}{2} )}^{40}}$$

The quarterly yield is 2.2059%.

For a SEN investor, the redemption value of the note can be calculated, since it is already known that this investor should earn an annual yield of 8.8235%. It is also known that the price of the note today is $6.46. Like the PELTS investor, this investor will, accrue interest income at a rate of 95% of the annual stock dividend yield of 3%.

Recall that:

F=P(1+y)^{N}

Then:

F=$6.46(1.088235)¹⁰

The value of the SEN at redemption is $15.0475, and the redemption values are $15.3188 and $15.4622 on a semi-annual and quarterly basis, respectively.

Next, it is assumed that there is an investor that wishes to receive payments in perpetuity in exchange for an investment equivalent to buying a PELTS share. It is already known what the present value of this perpetuity should be. It is also known that the annual, semi-annual, and quarterly yield that should be applied in order to determine the present value of the perpetuity. Thus the periodic cash flows that this investor is entitled to receive can be determined.

If CF represents a periodic cash flow and i represents the applicable interest, rate, then present value of the perpetuity can be calculated from:

$$P = \frac{CF}{i}$$

To remain consistent with what is set forth above:

$$P = \frac{CF}{y}$$

### Thus:

CF=P×y

Remember that P=$6.46 and that y is equal to 8.8235%, 4.4118% and 2.2059% on annual, semi-annual and quarterly basis, respectively. Therefore, this investor could receive $0.5700 at the end of every year, or $0.2850 at the end of every six months, or $0.1425 at the end of every quarter, in perpetuity.

A numerical calculation of R for the DELTS investor under the assumption that, the constant dividend payments are reinvested at a rate of return r, can be performed as follows. In order to avoid contusion, Rᵣ can be used to represent the DELTS investor's implied growth rate given the 10-year hurdle rate that has already been calculated assuming reinvested dividends.

Recall that:

$${R}_{r} = {[ ( 1 + \frac{{\sum }_{i = 1}^{N} [ {D}_{{Y}_{i}} \times {( 1 + {r}_{i} )}^{i} ]}{{H}_{N}} ) - {\sum }_{i = 1}^{N} [ {D}_{{Y}_{i}} \times {( 1 + {r}_{i} )}^{i} ] ]}^{\frac{1}{N}} - 1$$

### So:

$${R}_{r} = {[ ( 1 + \frac{0.3428}{0.3230} ) - 0.3428 ]}^{\frac{1}{10}} - 1$$

$${R}_{r} = {[ 1.7182 ]}^{\frac{1}{10}} - 1 = 5.5638 \%$$

Thus, the rate of return with reinvested dividends is more attractive than the rate of return with no reinvestment of dividends.

In accordance with some embodiments, mechanisms can be provided to perform one or more of the following;
1) Provide investors (which can be pre-approved and/or pre-screened) with access to a computerized, electronic trading venue where the transactions described herein can take place.
2) Electronically gather information and gauge investor interest in the equity pool and collect corresponding data on EDR, growth rates, and/or hurdle rates from those investors, and/or any other suitable data.
3) Display an array of prices for DELTS that investors can select from.
4) Electronically gather information and gauge investor interest in the debt pool and collect data on their expected or desired yield and/or any other suitable data.
5) Display an array of yields for PELTS and SEN corresponding to available DELTS.
6) Match debt pool investors with appropriate equity pool investors.
7) Execute trades required to purchase regularly trading dividend-paying stock, on the public-equity markets and create the three new securities that are based on each particular purchased share.
8) Assign the newly created securities (equity and debt) to each investor that has purchased an ownership right to the security.
9) Administer the functions required to ensure that each investor in the new securities receives the benefit of ownership of that security.
10) Maintain custody records of any unsold pieces., and provide information about these unsold pieces to investors that may have an interest in purchasing them.
11) Conduct periodic auctions of voting shares in the Voting Pool
12) Administer the collection and delivery of physical original and duplicate copies of certificates representing ownership of the underlying dividend-paying shares, and the printing, collection or delivery of physical certificates representing the deconstructed components of the underlying shares.
13) Maintain electronic ownership records of certificates for shares and deconstructed shares not delivered in physical form.
14) Retire, or redeem newly created securities when appropriate, and administer all functions required to ensure that the underlying dividend-paying shares go back into general circulation by selling them back to buyers on the equity markets after they have been reconstituted from their deconstructed components (i.e., DELTS, PELTS and/or SEN, and Voting Shares).

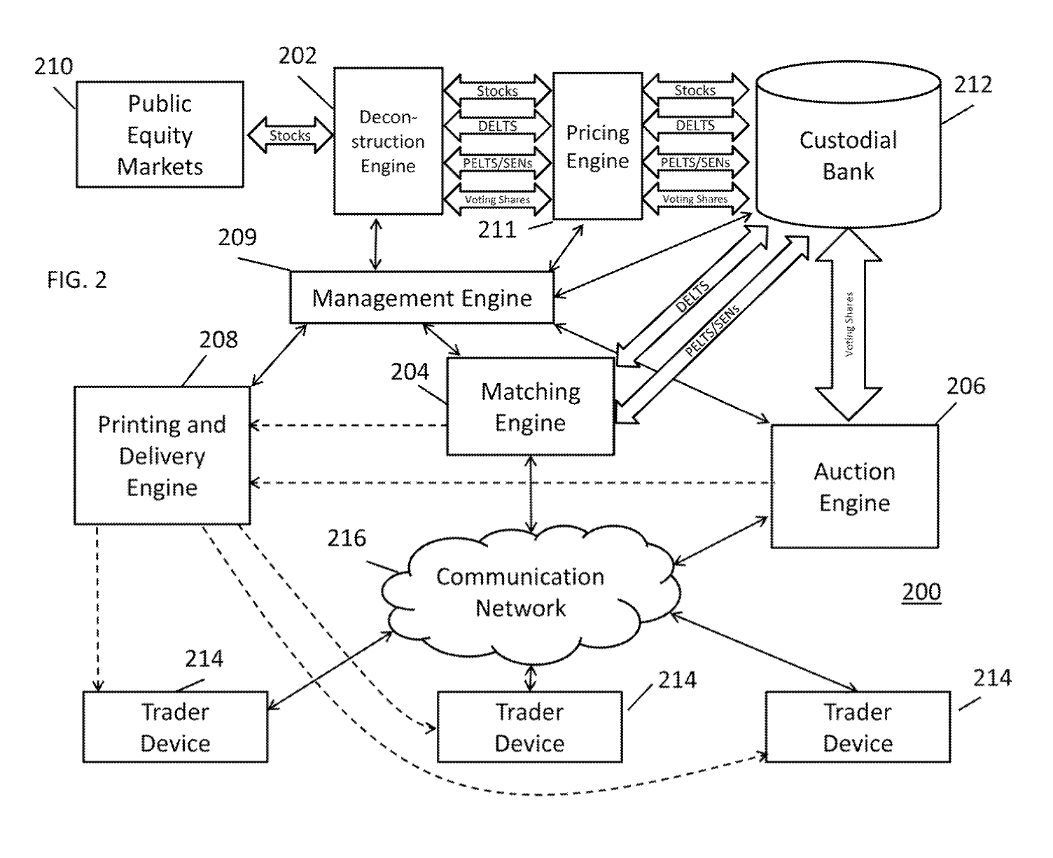

Turning to FIG. 2, an example of a mechanism 200 for providing such functions in accordance with some embodiments is illustrated. As shown, mechanism 200 can include a deconstuction engine 202, a matching engine 204, an auction engine 206, a printing and delivery engine 208, a management engine 209. and a pricing engine 21L Deconstruction engine can be any suitable process(es) and/or device(s) for obtaining a stock from public equity markets 210, constructing DELTS, PELTS and/or SEN, and Voting Shares, and providing the stock, DELTS, PELTS and/or SEN, and Voting Shares to pricing engine 21 L Matching engine 204 can be any suitable process(es) and/or devicefs) for presenting and receiving information on tradable DELTS, PELTS, and/or SEN to/from investors interacting with the matching engine via a trader device 214 and a communication network 216, and enabling those investors to execute trades DELTS, PELTS, and/or SEN via any suitable process, such as an auction. Auction engine 206 can be any suitable process(es) and/or devicefs) for providing an online auction for buying Voting Shares to investors accessing the auction engine from trader devices 214 and communication network 216. Printing and delivery engine 208 can be any suitable processes) and/or devicefs) for printing and delivering securities, records of trades, etc. Management engine 209 can be any suitable process(es) and/or devicefs) for overseeing the functions of the other engines, for performing risk management functions, for controlling portfolio expansion/contTaction/baiaiicing, and/or for performing any other suitable functions. Pricing engine 211 can be any suitable processes) and/or devicefs) for deriving, tracking, and continuously updating pricing of the DELTS, PELTS, and/or SEN based on what is taking place in the market.

In some embodiments, deconstuction engine 202, matching engine 204, auction engine 206, printing and delivery engine 208, management engine 209, and/or pricing engine 211 can be implemented, in one or more computing devices. Similarly, public equity markets 210, custodial bank 212, and trader devices 214 can include one or more computing devices for communicating with engines 202, 204, 206, 208, 209, and 211 in some embodiments. Communication network 216 can be any suitable communication network or combination of networks, and can include the Internet, local area networks, wide area networks, wired networks, wireless networks, data networks, telephone networks, cable television networks, satellite networks, etc.

More particularly, for example, any of the computing devices for engines 202,204, 206, 208, 209, and/or 211 and/or public equity markets 210, custodial bank 212, and trader devices

214 can be any of a general purpose device such as a computer or a special purpose device such as a client, a server, etc. Any of these general or special purpose devices can include any suitable components such as a hardware processor (which can be a microprocessor, digital signal processor, a controller, etc.). memory, communication interfaces, display controllers, input devices, etc. For example, trader devices 214 can be implemented as a personal computer, a personal data assistant (PDA), a portable email device, a multimedia terminal, a mobile telephone, a smart phone, a tablet computer, a set-top box, a television, etc.

In some embodiments, any suitable computer readable media can be used for storing instructions for performing the processes and/or functions described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

While techniques, calculations, and mechanisms based on use of discrete dividends are described herein, it should be apparent to one of ordinary skill in the art that these techniques, calculations, and mechanisms can additionally or alternatively be perforated using continuous dividends by modifying the techniques, calculations, and mechanisms to use continuous dividend instead of discrete dividends as known in the art.

While techniques, calculations, mechanism and processes based on dividend-paying stocks are described herein, it should be apparent to one of ordinary skill in the art that these techniques, calculations, mechanism, and processes for creating DELTS, PELTS/SEN and Voting Shares can additionally or alternatively be performed for non-dividend paying stocks of issuing companies that meet certain thresholds of financial strength.

Although the invention has been described and illustrated in the foregoing illustrative embodiments, it is understood that the present disclosure has been made only by way of example, and that numerous changes in. the details of implementation of the invention can be made without departing from the spirit and scope of the invention, which is only limited by the claims which follow. Features of the disclosed embodiments can be combined and rearranged in various ways.

1. A system for trading deconstructed stocks comprising:
at least one hardware processor that:
obtains a share of a stock from a public equity market;
constructs an equity only share, a dividend only share, and a voting right only share corresponding to the stock;
determines a first price for the equity only share;
determines a second price for the dividend only share;
presents the first price to a first of two traders;
presents the second price to a second of two traders;
matches trading interests between the two traders involving the equity only share and dividend only share; and
executes a trade between the two traders involving the equity only share and dividend only share.

2. The system of claim 1, wherein the hardware processor also:
receives a selection of a hurdle rate and a dividend growth rate;
determines a plurality of first prices for the equity only shares; and
presents the plurality of first prices to the first of the two traders.

3. The system of claim 2, where the plurality of .first prices are presented with different equity discount rates.

4. The system of claim 1, wherein the hardware processor determines a yield for the dividend only shares.

5. The system of claim 1, wherein the hardware processor also:
determines a plurality of second prices based on the first price and a yield corresponding to each of the plurality of second prices; and
presents the plurality of second prices to the second of the two traders.

6. The system of claim 1, wherein the hardware processor also executes an auction for the voting right only shares.

7. A method for trading deconstructed stocks comprising:
obtaining a share of a stock from a public equity market using at least one hardware processor;
constructing an equity only share, a dividend only share, and a voting right only share corresponding to the stock using the at least one hardware processor;
determining a first price for the equity only share using the at least one hardware processor;
determining a second price for the dividend only share using the at least one hardware processor;
presenting the first price to a first of two traders using the at least one hardware processor;
presenting the second price to second of two traders using the at least one hardware processor;
matching trading interests between the two traders involving the equity only share and dividend only share using the at least one hardware processor; and
executing a trade between the two traders involving the equity only share and dividend only share using the at least one hardware processor.

8. The method of claim 7, further comprising:
receiving a selection of a hurdle rate and a dividend growth rate;
determining a plurality of first prices for the equity only shares; and
presenting the plurality of first prices to the first of the two traders.

9. The method of claim 8, where the plurality of first prices are presented with different equity discount rates.

10. The method of claim 7, further comprising deteraiining a yield for the dividend only shares.

11. The method of claim 7, farther comprising:
determining a plurality of second prices based on the first price and a yield corresponding to each of the plurality of second prices; and
presenting the plurality of second prices to the second of the two traders.

12. The method of claim 7, further comprising executing an auction for the voting right only shares.

13. A non-transitory computer-readable medium containing computer-executable instructions that, when executed by a processor, cause the processor to perform a method for trading deconstructed stocks, the method comprising;
obtaining a share of a stock from a public equity market;
constructing an equity only share, a dividend only share, and a voting right only share corresponding to the stock;
determining a first price for the equity only share;
determining a second price for the dividend only share;
presenting the first price to a first of two traders;
presenting the second price to second of two traders;
matching trading interests between the two traders involving the equity only share and dividend only share; and
executing a trade between the two traders involving the equity only share and dividend only share.

14. The non-transitory computer-readable medium of claim 1.3, wherein the method further comprises:
receiving a selection of a hurdle rate and a dividend growth rate;
determining a plurality of first prices for the equity only shares; and
presenting the plurality of first prices to the first of the two traders.

15. The non-transitory computer-readable medium of claim 14, where the plurality of first prices are presented with different equity discount rates.

16. The non-transitory computer-readable medium of claim 13, wherein the method further comprises determining a yield for the dividend only shares.

17. The non-transitory computer-readable medium of claim 13, wherein the method further comprises:
determining a plurality of second prices based on the first price and a yield corresponding to each of the plurality of second prices; and
presenting the plurality of second prices to the second of the two traders.

18. The non-transitory computer-readable medium of claim 13, wherein the method further comprises executing an auction for the voting right only shares.
